(19) United States
(12) Patent Application Publication
(10) Pub. No.: US 2025/0006071 A1
(43) Pub. Date: Jan. 2, 2025

(54) DYNAMIC CURRICULUM ALIGNMENT

(71) Applicant: International Business Machines Corporation, Armonk, NY (US)

(72) Inventors: Utkarsh Pandey, Toronto (CA); Aiman Aziz Khan, Brampton (CA); Natalie Brooks Powell, Bolingbrook, IL (US); Zachary A. Silverstein, Georgetown, TX (US)

(21) Appl. No.: 18/345,220

(22) Filed: Jun. 30, 2023

(51) Int. Cl. G09B 5/02

(52) U.S. Cl. CPC G09B 5/02; G09B 19/0053

(57) ABSTRACT

Disclosed embodiments provide techniques for dynamically aligning curriculum to demonstration environment performance of a user. A user's action including an interaction with an element of curriculum material in the demonstration environment is obtained and a machine learning model determines a proficiency of the user with the curriculum material. Values indicating the proficiency are assigned to a profile of the user, from which a curriculum placement for the user is determined. This placement accelerates the user over lessons having material over which the user is already proficient according to the profile. The user is then presented with a lesson from the determined curriculum placement.

### FIELD

The present invention relates generally to computerized curriculum customization, and more particularly, to solutions for dynamically aligning curriculum to demonstration environment performance of a user.

### BACKGROUND

Computerized learning and training are often used to teach users new skills. This learning/training is not only limited to formal education but can often be used to teach skills needed for employment, such as learning how to best use a new software program for a job. Training can help users improve their skills and knowledge, which can make them more valuable to their organization. With the right training, users can develop new abilities, enhance existing ones, and become more proficient in their work or other tasks. Additionally, effective training can lead to increased productivity. As users gain new skills, they can complete tasks more quickly and accurately, resulting in greater output and improved quality.

Often, computerized learning/training can include at least two components: static course material (e.g., slideshows, readings, videos, other recordings) and a demonstration environment wherein a user can practice the teachings of the course material. For example, after a user has completed a lesson on object-oriented programing in a particular programing language, the user may be taken to a command window and given the opportunity to create an object using that programing language. However, while a demonstration environment may provide a user with an opportunity to practice a newly learned skill, the user must still sit through the same static course material, regardless of how well or poorly they have mastered particular skills.

### SUMMARY

Disclosed embodiments provide techniques for dynamically aligning curriculum to demonstration environment performance of a user. A user's action including an interaction with an element of curriculum material in the demonstration environment is obtained and a machine learning model determines a proficiency of the user with the curriculum material. Values indicating the proficiency are assigned to a profile of the user, from which a curriculum placement for the user is determined. This placement accelerates the user over lessons having material over which the user is already proficient according to the profile. The user is then presented with a lesson from the determined curriculum placement.

One aspect of the present invention includes a computer-implemented method for dynamically aligning curriculum to demonstration environment performance of a user, comprising: obtaining an action of the user in the demonstration environment, wherein the action comprises an interaction with an element of curriculum material; determining a proficiency of the user with the curriculum material by applying a machine learning model to the action; assigning, based on the determination, at least one value to a profile of the user indicating a proficiency of the user with the curriculum material; determining a curriculum placement of the user based on the profile, the curriculum placement accelerating the user over a lesson having material over which the user is proficient according to the profile; and presenting the user with a lesson from the determined curriculum placement.

Another aspect of the present invention includes an electronic computation device comprising: a processor; a memory coupled to the processor, the memory containing instructions, that when executed by the processor, cause the electronic computation device to: obtain an action of the user in the demonstration environment, wherein the action comprises an interaction with an element of curriculum material; determine a proficiency of the user with the curriculum material by applying a machine learning model to the action; assign, based on the determination, at least one value to a profile of the user indicating a proficiency of the user with the curriculum material; determine a curriculum placement of the user based on the profile, the curriculum placement accelerating the user over a lesson having material over which the user is proficient according to the profile; and present the user with a lesson from the determined curriculum placement.

Yet another aspect of the present invention includes a computer program product for an electronic computation device comprising a computer readable storage medium having program instructions embodied therewith, the program instructions executable by a processor to cause the electronic computation device to: obtain an action of the user in the demonstration environment, wherein the action comprises an interaction with an element of curriculum material; determine a proficiency of the user with the curriculum material by applying a machine learning model to the action; assign, based on the determination, at least one value to a profile of the user indicating a proficiency of the user with the curriculum material; determine a curriculum placement of the user based on the profile, the curriculum placement accelerating the user over a lesson having material over which the user is proficient according to the profile; and present the user with a lesson from the determined curriculum placement.

Still yet, any of the components of the present invention could be deployed, managed, serviced, etc., by a service provider who offers to implement dynamically aligning curriculum to demonstration environment performance of a user in a computer system.

Embodiments of the present invention also provide related systems, methods, and/or program products.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a flowchart indicating process steps for embodiments of the present invention.

FIG. 4 is an information flow in accordance with disclosed embodiments.

FIG. 5 depicts a process flowchart for dynamically aligning curriculum to demonstration environment performance of a user according to illustrative embodiments.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Skills training can be an important part of staying up to date in a career or other work. While a person may have skills and knowledge in a particular field, those skills may become outdated or require supplemental material as advancements are made in that field. Some people may alternatively be newly learning all skills in a particular field. This can result in users with very different backgrounds and levels of proficiency both studying the same coursework. Online and other computerized courses may assume that all users start from a place of zero knowledge in order to make sure that even the greenest user is able to follow along and grasp the teachings of a computerized lesson. This approach, however, can leave more seasoned users, who are only looking to augment existing skills, bored and forced to listen to course material in which they are already proficient. Such redundant learning is inefficient. Accordingly, it is desirable to assess in which material, if any, from a curriculum a user is already proficient, and permit that user to skip over such material. While proficiency testing may be used at the beginning of coursework to assess a user's competence in the material and therefore where in the material to place them, such proficiency tests are cumbersome. Proficiency testing can discourage new students, who may feel that they failed the exam, while trying the patience of more knowledgeable users, who may find the testing to be tedious.

Accordingly, embodiments of the present invention enable use of demonstration environments already integrated into a learning system to dynamically assign users appropriate lessons from a curriculum, while bypassing material that would be inefficient to show the user. Many learning systems offer users an opportunity to practice skills learned during static “classroom” content in a parallel demonstration (“demo”) environment. These demonstration environments can take many forms, from specific “try-it yourself” prompts to open sandboxes that permit all functionality (e.g., of a software) to be exercised. In any case, according to embodiments of the present invention, users who take actions in the demonstration environment that correlate with future coursework can be aligned with coursework that best fits their existing behaviors, thereby making e-learning dynamic. This enables a curriculum to be presented to a user more efficiently, skipping over already-known material, without the need for proficiency testing. It will be appreciated that embodiments of the present invention can be applied to a broad selection of computerized learning. In some non-limiting examples, embodiments of the present invention can be used to automate corporate training or as a component of virtual information technology (IT) training.

Disclosed embodiments provide techniques for dynamically aligning curriculum to demonstration environment performance of a user. A user's action including an interaction with an element of curriculum material in the demonstration environment is obtained and a machine learning model determines a proficiency of the user with the curriculum material. Values indicating the proficiency are assigned to a profile of the user, from which a curriculum placement for the user is determined. This placement accelerates the user over lessons having material over which the user is already proficient according to the profile. The user is then presented with a lesson from the determined curriculum placement.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

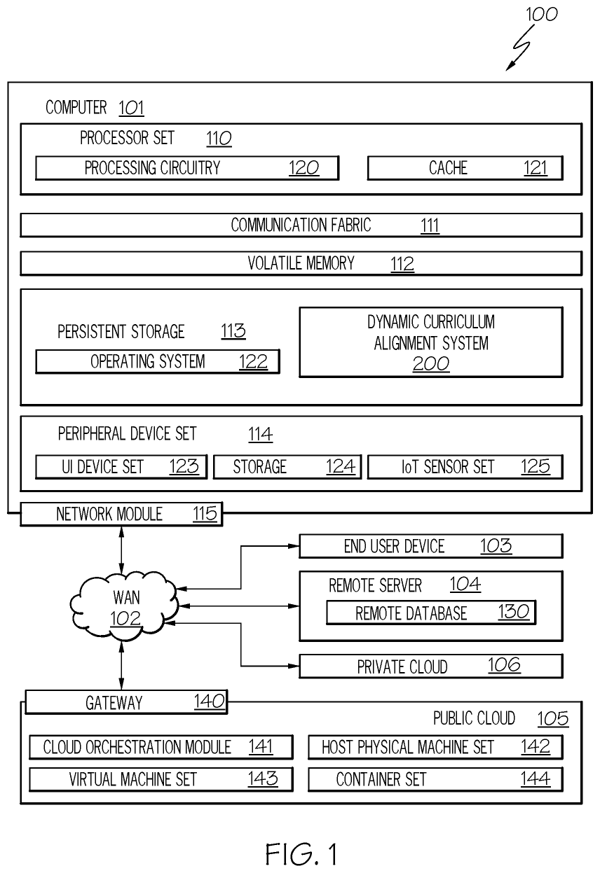

FIG. 1 shows an exemplary computing environment 100 in accordance with disclosed embodiments. Computing environment 100 contains an example of an environment for the execution of at least some of the computer code involved in performing the inventive methods, such as dynamic curriculum alignment system shown at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

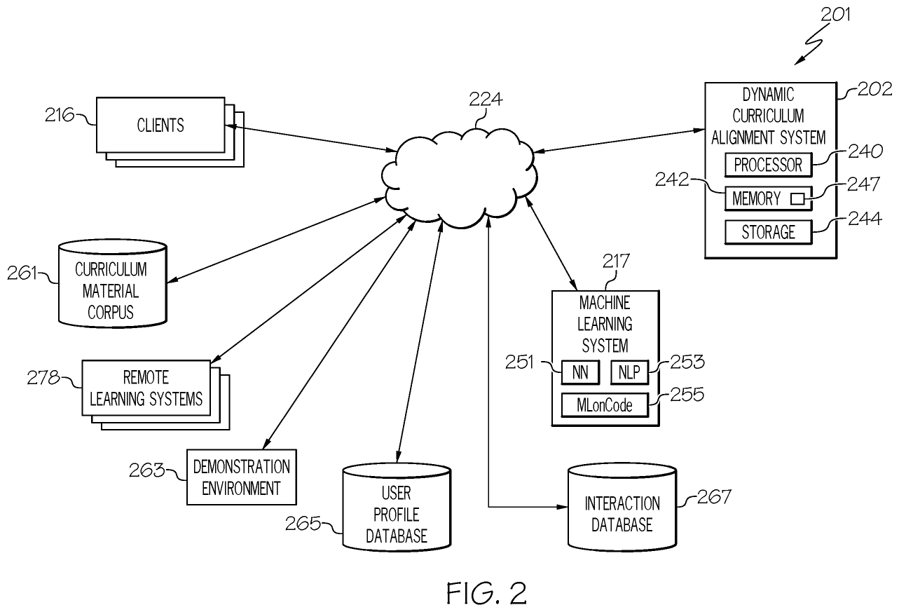

FIG. 2 is an exemplary ecosystem 201 in accordance with disclosed embodiments. Dynamic curriculum alignment system 202 comprises a processor 240, a memory 242 coupled to the processor 240, and storage 244. Dynamic curriculum alignment system 202 is an electronic computation device. The memory 242 contains program instructions 247, that when executed by the processor 240, perform processes, techniques, and implementations of disclosed embodiments. Memory 242 can include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The dynamic curriculum alignment system 202 is configured to interact with other elements of ecosystem 201. Dynamic curriculum alignment system 202 is connected to network 224, which is the Internet, a wide area network, a local area network, or other suitable network.

Ecosystem 201 may include one or more remote learning systems 278. The remote learning system 278 can include servers and backend applications for hosting and providing online video lessons and an online portal for taking self-assessments, and/or other activities for promotion of learning and assessment of educational material.

Ecosystem 201 may include one or more client devices, indicated as 216. Client device 216 can include a laptop computer, desktop computer, tablet computer, or other suitable computing device. Client device 216 may be used to interact with remote learning system 278 to enable end-users to provide training via online courses, including, but not limited to, online programming courses. The programming courses can present education material and provide assessments for languages such as C, C++, Python, bash, Java, JavaScript, and/or other programming languages. Additionally, other technical and/or business topics can be taught by remote learning systems 278 instead of, or in addition to, programming languages. Additionally, client device 216 may be used to carry out features in the dynamic curriculum alignment system 202, including features such as obtaining actions of a user in a demonstration environment, determining a curriculum placement of the user, and presenting the user with a lesson from the determined curriculum placement.

Ecosystem 201 may include machine learning system 217. The machine learning system 217 can include a neural network (NN) 251 (including, but not limited to, a recurrent neural network (RNN)), and/or a natural language processing (NLP) module 253. In some embodiments, the machine learning system 217 may include a Support Vector Machine (SVM), Decision Tree, Recurrent Neural Network (RNN), Long Short Term Memory Network (LSTM), Radial Basis Function Network (RBFN), Multilayer Perceptron (MLP), and/or other suitable neural network type. In embodiments, the machine learning system 217 is trained using supervised learning techniques.

The NLP module 253 may include software and/or hardware for performing Natural Language Processing (NLP). NLP is a subfield of artificial intelligence that involves teaching computers to understand, interpret, and generate human language. NLP works by breaking down human language into its constituent parts and analyzing them using various algorithms and techniques. In one or more embodiments, the NLP process includes tokenization, which can include breaking down a piece of text into individual words or phrases. The NLP process can further include Part-of-speech (POS) tagging. POS tagging can include analyzing each token and assigning it a part of speech, such as noun, verb, adjective, or adverb. The NLP process can further include parsing, which involves analyzing the syntactic structure of a sentence to identify the relationships between the words and phrases. The process can include entity detection, which involves identifying and categorizing named entities in a piece of text, such as people, places, organizations, and dates. One or more embodiments can include performing sentiment analysis. The sentiment analysis can include analyzing the overall sentiment or emotional tone of a piece of text, such as whether it is positive, negative, or neutral. Finally, the results of the NLP process may be further refined using post-processing techniques such as entity co-reference resolution and/or disambiguation. In disclosed embodiments, the entity detection extracts keywords and meanings from curriculum material corpus 261 (discussed in more detail below), in order to determine skills taught therein, in accordance with embodiments of the present invention.

In one or more embodiments, the machine learning system 217 further includes an MLonCode (Machine Learning on Code) module 255 or other module configured to analyze the functionality of user-inputted entries in demonstration environment 263 (discussed in further detail below). MLonCode (Machine Learning on Code) refers to the use of machine learning techniques to analyze and understand code. MLonCode aims to improve software development processes by automating various tasks such as code review, bug detection, code completion, and refactoring. MLonCode algorithms can be used to classify code according to its type, purpose, or functionality. This can be useful for organizing and searching code repositories, and for identifying patterns or trends in code usage. MLonCode algorithms can be used to detect bugs or errors in code by analyzing its syntax and structure. This can help developers to identify and fix bugs more quickly and efficiently. In embodiments, MLonCode algorithms can be trained to evaluate code submitted in demonstration environment 263 to ascertain a user's proficiency in a given programming language. In some embodiments, MLonCode can be used to analyze the effectiveness of source code, including evaluation of demonstration environment elements for determining a user proficiency in material of a curriculum. Disclosed embodiments may utilize xAPI and/or other suitable techniques for tracking and administering demonstration environment elements.

xAPI (Experience API), is a standard for tracking and communicating learning experiences and related data. xAPI is designed to capture a wide variety of learning experiences beyond traditional e-learning courses, including simulations, virtual reality experiences, games, mobile learning, and informal learning. It allows the tracking of learning experiences that occur both online and offline, and across multiple platforms and devices. xAPI is based on a simple statement structure that consists of a subject, verb, and object. These statements can be sent from any source, such as a learning management system (LMS), a mobile app, or a web browser, to a repository (e.g., Learning Record Store) that securely stores and manages the assessment data.

Ecosystem 201 includes a curriculum material corpus 261. The curriculum material corpus 261 can include digital assets such as text, audio, images, video, and/or interactive content. The curriculum material corpus 261 may utilize a database, such as a structured query language (SQL) database, to store and/or index the content within the curriculum material corpus 261. The content within the curriculum material corpus 261 may be organized into chapters, lessons, subchapters, etc. In embodiments, the curriculum material corpus includes text, audio, and/or at least one image. In one or more embodiments, educational video assets are analyzed to determine educational material, including a skill-set, taught in each organizational section. As an example, an educational video asset can contain a first chapter on wired ethernet, a second chapter on WiFi, and a third chapter on router configuration. If a demonstration environment assessment indicates that a user can set up a WiFi network, but is unfamiliar wired ethernet and router configurations, then disclosed embodiments can compile a subset of the plurality of sections into a new educational video asset that includes the first chapter and the third chapter, but without the second chapter. Thus, the new educational video asset fast-tracks a user past material with which (s)he is already proficient, thereby saving time for users that need to learn new skills quickly and efficiently.

Ecosystem 201 includes a demonstration environment 263. This demonstration environment 263 can be any demonstration environment intended to function in parallel with more traditional, static coursework, such as that found in curriculum material corpus 261 (e.g., readings, audio, videos). Generally speaking, demonstration environment 263 can be any sandbox customized to permit interaction with elements discussed in curriculum material corpus 261. Moreover, such elements can be associated with particular placements in curriculum material corpus 261. In some embodiments, demonstration environment 263 can be a virtual simulation that allows a user to practice teachings or processes from curriculum material corpus 261. For example, if curriculum material corpus 261 is intended to teach a user how to use a software, then demonstration environment 263 can be a running application (either with full capabilities, or with limited classroom capabilities) of that software, configured to allow the user to interact with and use elements or features of the application. In other words, demonstration environment 263 presents a setting in which a user can practice their ability to carry out the teachings of curriculum material corpus 261. In some embodiments, demonstration environment 263 can be a virtual machine running, e.g., a software application the use of which is being taught in the curriculum material corpus 261. In some further embodiments, demonstration environment 263 can include a collection of tests, quizzes, homework problems, and the like, to be practiced in demonstration environment 263.

In some embodiments, demonstration environment 263 may include one or more digital twins of real-world objects being learned or studied (e.g., an automobile engine in a mechanic's course). A digital twin is a digital replica of a product, process, or service. This living model creates a thread between the physical and digital world. IoT-connected objects are replicated digitally, enabling simulations, testing, modeling, and monitoring based on data collected by IoT sensors. Like everything in the realm of IoT, data is the primary driver, and most invaluable output, of digital twins. The sharing and analysis of digital twin data can allow demonstration environment 263 to replicate the user's real-world interactions with a studied item, thereby integrating such interactions into system 202.

Ecosystem 201 includes a user profile database 265. The user profile database 265 can include information pertaining to a user. The information can include education level, self-reported skills, assessed skills, certifications, and so on. The user profile database can also include learning preferences for the user. The learning preferences can include a variety of attributes, such as a time range preference. As an example, some users may prefer training courses that take no longer than two weeks to complete, while other users may prefer longer courses such as semester or full year courses. The learning preferences can include a cost range. As an example, some users may prefer training courses that are free or under a predetermined cost, while for other users, more expensive courses are acceptable. The learning preferences can include an instruction type preference. As an example, some users prefer remote learning, while other users may prefer in-person learning. With remote learning, some users may prefer completely asynchronous learning, while other users may prefer instructor-led remote learning.

As a user interacts with elements of demonstration environment 263, additional skills and proficiencies, determined according to embodiments of the present invention, can be added to user profile database 265. Furthermore, as a user interacts with elements of demonstration environment 263, incompetences and deficiencies (i.e., skill areas which the user has yet to learn or master), also determined according to embodiments of the present invention, can also be added to user profile database 265 as material which should not be skipped over in the curriculum material corpus 261.

Ecosystem 201 includes interaction database 267. The interaction database may include a SQL database, and/or other suitable database type. The interaction database can include output from machine learning system 217 that associates interactions with elements of demonstration environment 263 with proficiency, or lack thereof, in material from curriculum material corpus 261. Interaction database 267 can contain historical data showing previous user interactions with elements of demonstration environment 263 and which material from curriculum material corpus 261 can be skipped (without adversely affecting the user's learning) based on those interactions. According to some embodiments, levels of proficiency can be expressed by a value (e.g., numeric, percentage) or metadata tag. Nuances of interactions in demonstration environment 263 can also be characterized or weighted. For example, proficiency values can be assigned based on speed (e.g., time to launch an application, ability to log in quickly), confidence (e.g., deliberateness of actions), and/or success (e.g., obtainment of intended result) of the interaction.

According to embodiments of the present invention, machine learning system 217 can be trained on historical data showing previous user interactions with elements of demonstration environment 263 and stored in interaction database 267. This historical data can be derived from interactions between both historical and current students and elements of demonstration environment 263, as will be discussed in more detail below.

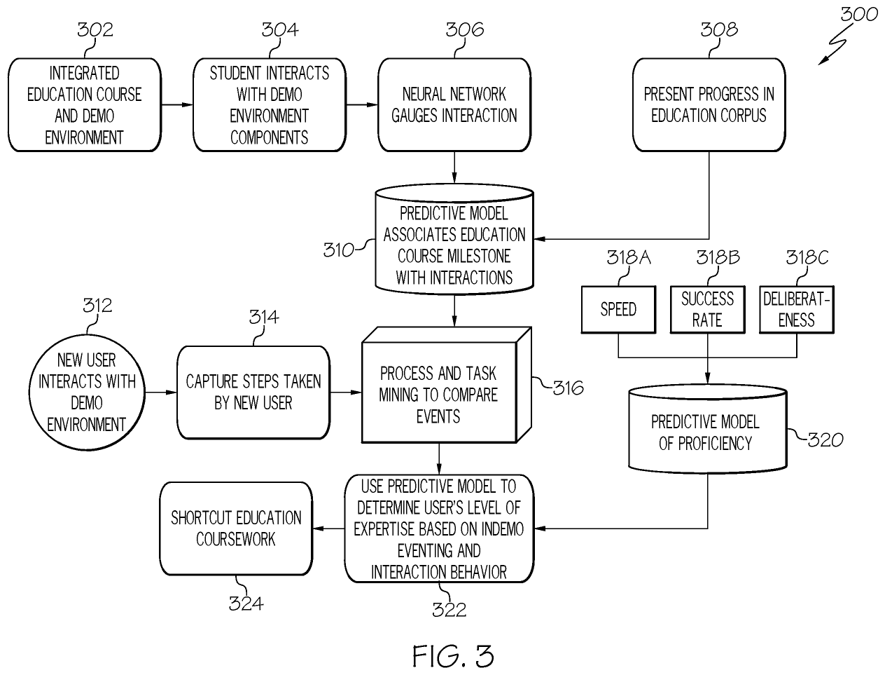

Referring now to FIG. 3 in conjunction with FIG. 2, a flowchart 300 indicating process steps for embodiments of the present invention is shown. A student at 302 enrolls in a class offered through a coursework education engine (e.g., remote learning system 278 according to some embodiments) which integrates an education course (curriculum material corpus 261) and a demonstration environment (demonstration environment 263). Demonstration environment 263 is connected to and reflects material in curriculum material corpus 261 of the education course. Moreover, the coursework education engine/remote learning system 278 can be configured to permit bi-modal progress tracking of the student both along a pathway of course progress as well as along a pathway of demonstration progress.

After completing a portion of coursework (e.g., a lesson, a video, a slideshow), the student is moved to demonstration environment 263 to practice the material taught in the coursework in a “hands-on” manner. While in demonstration environment 263, the student interacts with an element or other component of demonstration environment 263 at 304. Such interactions may include, merely as an example, writing a piece of code, starting a software application, or any other process taught in the coursework. These interactions can be captured, for example, from OS (operating system) level logs, application logs, or a process/task mining engine. At 306, neural network 251 judges or otherwise gauges the interaction. According to some embodiments, the interaction can be scored on multiple characteristics, such as speed, confidence, and/or success of the interaction. One or more identifiers, such as numeric code(s) can be used to represent particular characteristics and assigned to the interactions. Therefore, interactions having similar characteristics can be easily correlated or grouped for analysis using techniques such as co-sine similarity. These characteristics of the interaction can be stored in interaction database 267 and correlated with the student's present progress 308 in the education corpus. At 310, a predictive model component of machine learning system 217 can associate (e.g., by techniques such as co-sine similarity) education course milestones indicative of placement within a coursework (e.g., completing a lesson) with likely interactions in demonstration environment 263 (e.g., successfully and promptly completing a task).

According to disclosed embodiments, machine learning system 217 can use kNN (nearest neighbors), K-means, random forest, clustering, and/or other suitable techniques for identifying interactions most closely associated with the same education milestone. These milestones can be statically derived from a manual/hardcoded mapping an administrator creates or dynamically derived based on monitoring and interactions along various steps of the coursework, as shown in an interaction history of demonstration environment 263.

The k-Nearest Neighbors (kNN) algorithm works by finding the k nearest neighbors in the training data to a new data point and using the majority class (for classification) or the mean value (for regression) of their outputs as the prediction for the new point. In embodiments, the distance between data points can be measured using Euclidean distance, but other distance metrics can be used in some embodiments.

K-means is an unsupervised machine learning algorithm for clustering data into groups based on their similarities. It is used to identify patterns in data and is often used for segmentation or categorization tasks. The algorithm works by partitioning a set of data points into k clusters, where k is a predetermined number chosen by a user. The algorithm then iteratively assigns each data point to the cluster with the nearest mean (center) and recalculates the mean of each cluster based on the data points assigned to it. This process continues until the clusters converge to a stable solution.

Random forest is a supervised machine learning algorithm used for classification, regression, and other prediction tasks. It is an ensemble learning method that builds multiple decision trees and combines their predictions to produce a more accurate and robust model. The random forest algorithm works by constructing a large number of decision trees, each based on a random subset of the training data and a random subset of the features. During the construction of each tree, the algorithm splits the data into subsets based on the values of the selected features and chooses the best split to maximize the information gain. When making a prediction, the random forest algorithm combines the predictions of all the individual trees by either taking the mode (for classification) or the mean (for regression) of their outputs. This combination of multiple decision trees helps to reduce the risk of overfitting and makes the model more resilient to noise and outliers.

It should be understood that in embodiments where historical or current data from students is used to train and refine machine learning system 217, interactions by more advanced users can be filtered out of the training data (e.g., manually or by machine learning system 217 as it becomes more refined and able to differentiate an amateur student from one already proficient in some skills).

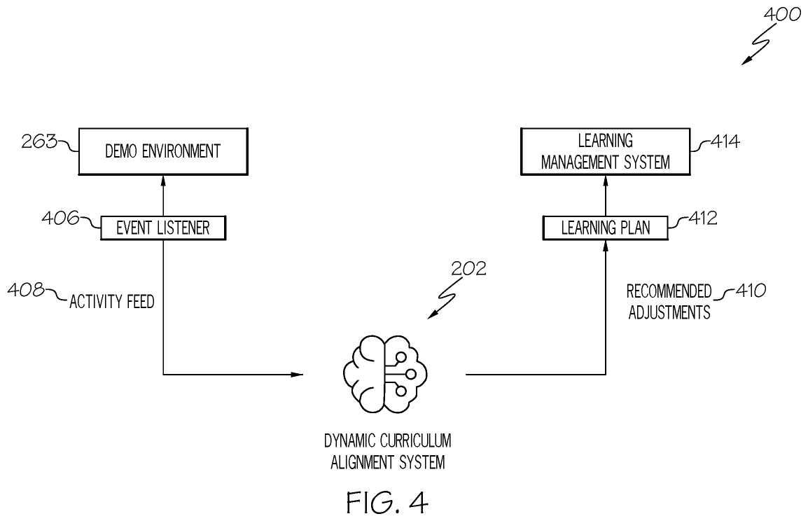

Continuing to refer to FIG. 2 and FIG. 3, reference is now also made to FIG. 4, which shows an information flow 400 in accordance with disclosed embodiments for dynamically aligning curriculum to demonstration environment performance of a user. At 312, a new user interacts with demonstration environment 263. In some embodiments, demonstration environment 263 can be presented to a new user as soon as they begin taking a course connected to system 202. In some other embodiments, the new user can be presented with a first lesson in curriculum material corpus 261, before being moved to demonstration environment 263 for practice.

In any case, event listener 406 can obtain an action of the user in demonstration environment 263. In some embodiments, event listener 406 can be an OS level logger, an application logger, or a process/task mining engine. Event listener 406 provides activity feed 408 to system 202, thereby at 314 providing system 202 with steps, actions, or other manipulations of the environment taken by the new user in demonstration environment 263. More specifically, event listeners 406 capture for system 202 a progress of the user in demonstration environment 263 and with what components and sub-applications the user has interacted. In some embodiments, event listeners 406 can also track a progress of the user in curriculum material corpus 261.

An action or other manipulation of demonstration environment 263 comprises at least one interaction with an element of curriculum material in demonstration environment 263. According to embodiments, this element of curriculum material can be any interactive digital item configured to simulate or otherwise produce or mimic, upon interaction, a process or effect taught in curriculum material corpus 261. According to embodiments of the present invention, demonstration environment 263 can be customized to curriculum material corpus 261. In some embodiments, demonstration environment 263 can be a virtual sandbox customized to the curriculum material. In such an instance, the full functionality of the subject of study (e.g., a software) will be made accessible to the user. In still other embodiments, demonstration environment 263 can be a limited practice mode, where substantially only elements intended for interaction are made available to manipulate. The purpose of such a limited environment may be, for example, to reinforce a process of the curriculum material corpus 261.

According to some embodiments of the present invention, some or all elements of demonstration environment 263 can be mapped (e.g., by machine learning system 217 using curriculum material corpus 261 and interaction database 267) to particular placements in the curriculum material corpus 261). For example, if using a particular element successfully requires knowledge taught in Chapter Three, then that element can be mapped with Chapter 3. This mapping can be initially pre-set, but later refined after students provide the predictive model component of machine learning system 217 with interaction data (as discussed above with respect to process step 310) indicating what interactions are to be expected from students at particular milestones in the coursework.

In an illustrative example, demonstration environment 263 can be configured to provide the same functions as a file management software that the user is learning to use. In such an instance, examples of an action taken by the user in demonstration environment 263 may include, but are not linked to, applications interacted with, folders opened, files opened, sites visited, and any other associated live interaction that generate metadata.

In addition to logging action events in demonstration environment 263, event listeners 406 can collect data that characterizes and/or contextualizes the action/event. For example, event listener 406 can collect user input characteristics, such as timing, mouse movements, keyboard strokes, etc., which can be analyzed, as discussed further below, to determine a speed, confidence, and/or success of the interaction with the element. Event listener 406 can also have collected historical context data of similar actions, events, or other interactions in order to permit system 202 to establish an interaction characteristic baseline.

Machine learning system 217 can compare an interaction by a user in demonstration environment 263 through techniques, such as task mining, against historic interaction events stored in interaction database 267 at 316. According to some embodiments, machine learning system 217 can analyze the interaction and apply indicators or other numeric values characterizing the interaction. Such indicators can be stored in a profile associated with the user in user profile database 265. These indicators can be cross-referenced with interaction data in interaction database 267 to find instances (e.g., using techniques such as co-sine similarity) of similar historic interactions having matching or at least substantially similar characteristics. A predictive model of proficiency 320 included in machine learning system 217 can then determine the user's proficiency at 322 in curriculum material corpus 261 based on further cross-referencing and other associations in interaction database 267 to a placement in curriculum material corpus 261. It should be understood that, while the present description primarily discusses a user having a proficiency in a skill area, deficient skills or non-skills are also within the spirit of the invention.

For instance, continuing the file management software training example from above, the user may be annotating files with metadata tags, a technique that is not learned until chapter 5 of curriculum material corpus 261. Predictive model of proficiency 320 can add a value representing the interaction to the user's profile, indicating that the user is successfully adding metadata tags to files in demonstration environment 263. Predictive model of proficiency 320 can access interaction database 267 to determine that historic interactions that included adding metadata tags to files are closely associated with chapter 5 learning. As such, predictive model of proficiency 320 can determine that the user is likely proficient in curriculum material corpus 261 through at least chapter 5 (and, using techniques discussed further below, most likely should be provided with chapter 6 learning materials).

Furthermore, according to embodiments of the present invention, machine learning system 217 and/or predictive model of proficiency 320 can also weight a contextualized application interaction effort based on success factors, not merely interaction quantity. Such contextualization can include, but is not limited to, speed of interaction 318A (e.g., ability to log in/launch an application quickly versus taking longer than average to do so; direct actions versus browsing around), success rate of interaction 318B (e.g., whether user-inputted commands act as intended or contained bugs), and confidence or deliberateness of interaction 318C (e.g., efficient mouse movements and/or keyboard strokes versus hesitant movements; logical progression of steps versus disorderly progress). These contextualization factors can also be assigned a rating (e.g., 0 to 100; low, medium, high) and used to give weight to a proficiency of a user in a particular knowledge area.

For example, continuing the file management software training example from above, while the user may be annotating files with metadata tags, he takes a long time to select a tag and sometimes chooses an inappropriate tag. In response, predictive model of proficiency 320 can assign the user's profile an indicator showing that he has knowledge of metadata tagging, while also including a linked indicator that his proficiency is only medium. As such, predictive model of proficiency 320 can determine that the user is only semi-proficient in chapter 5 of curriculum material corpus 261 (and, using techniques discussed further below, most likely should be provided with a chapter 5 refresher before engaging with further course material or being moved back to demonstration environment 263 for further evaluation). Although this example specifically speaks of chapters, it should be understood that curriculum material corpus 261 can be broken down into smaller levels, and users may be assigned to merely study a portion of a chapter. For instance, in the current example, system 202 may ultimately direct the user to watch lessons on selecting appropriate metadata tags but skip over a lesson explaining what a metadata tag is.

System 202 can recommend adjustments 410 to learning management system 414 (e.g., remote learning system 278) that controls a user's progress in curriculum material corpus 261. This recommendation is based on a determination by system 202 of a curriculum placement of the user based on the user's profile. Generally speaking, system 202 can recommend one or more lessons having material over which the user is proficient according to the user's profile and that, as such, the user should be accelerated over. According to embodiments, neural network 251 of machine learning system 217 can ingest the actual progress of the user (stored in the profile of the user) and the demonstration environment proficiency performance of the user (as entered into the profile by machine learning system 217), and find a closest alignment of the user's proficiency to that of historic individuals, and accelerates the user to the milestone in the coursework closest associated with those other user's proficiency. As such, learning management system 414 can present revised learning plan 412 to the user that shortcuts the user's education coursework at 324.

Embodiments of the present invention enable an intelligent self-adapting learning plan. Although the above describes but one iteration of a process to assess a user's proficiency based on demonstration environment performance and to accelerate the user's learning plan based on that assessed proficiency, it should be understood that this process may be repeated multiple times as a user goes back and forth from a static curriculum learning system and a dynamic demonstration environment. For example, after the user has listened to or otherwise taken an accelerated lesson (as recommended by system 202 using the methodologies above described), the user can be moved back into demonstration environment 263. In some embodiments, this demonstration environment 263 may be the same demonstration environment in which the user previously interacted. In still other embodiments, demonstration environment 263 can be a different demonstration environment or enhanced with new elements associated with the lessons up to and including the one the user has just completed.

Regardless, new, subsequent interactions of the user with elements of demonstration environment 263 are logged by event listeners 406 and fed into machine learning system 217. Machine learning system 217 can assign indicators to characterize the interaction and compare that characterized interaction to historical user interactions associated with particular placements in curriculum material corpus 261. Moreover, an earlier iteration of the user's profile can be compared to an updated iteration of the profile after machine learning system 217 has analyzed the most recent demonstration environment interactions and updated the user's profile with its findings. Based on a comparison of the profile iterations or other comparisons of the user's previous proficiency to the user's current proficiency, machine learning system 217 can determine whether the user successfully learned material in the lesson.

In the event the learning was a failure, this failure can be fed back into predictive model of proficiency 320 of machine learning system 217 to help train the model to recognize that a future user who shows proficiency levels similar to the current user's initial proficiency should not be accelerated to the place in coursework curriculum material corpus 261 to which the current user was accelerated. Contra, in the event machine learning system 217 determines the learning was a success, this success can be fed back into predictive model of proficiency 320 of machine learning system 217 to help reinforce the model's recommendations to accelerate a future user who shows proficiency levels similar to the current user to substantially the same milestone in coursework curriculum material corpus 261 to which the current user was accelerated. As such, an association, whether positive or negative, can be created in machine learning model 217 between the user's initial interaction, subsequent curriculum placement, and a success or failure assessment.

Moreover, in the event that machine learning system 217 determines that the learning was a failure, system 202 can recommend that the user retake the failed lesson and/or be moved to an even earlier section of curriculum material corpus 261 based on the user's most recent demonstration environment performance. On the other hand, in the event that machine learning system 217 determines that the learning was a success, system 202 can recommend that the user take the next lesson in curriculum material corpus 261 or be accelerated to an even further ahead lesson based on the user's most recent demonstration environment performance.

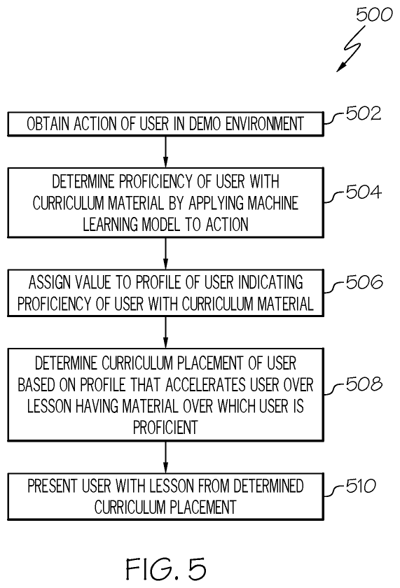

As depicted in FIG. 5, in one embodiment, a system (e.g., Dynamic curriculum alignment system 202) carries out the methodologies disclosed herein. Shown is a process flowchart 500 for provisionally scheduling resources in a cloud computing environment. At 502, an action of a user in demonstration environment 263 is obtained. This action comprises an interaction with an element of curriculum material in demonstration environment 263 from curriculum material corpus 261. At 504, a proficiency of the user is determined with curriculum material of curriculum material corpus 261 by applying machine learning model of machine learning system 217 to the action. At 506, at least one value is assigned to a profile of the user indicating a proficiency of the user with the curriculum material of curriculum material corpus 261 based on the determination. At 508, a curriculum placement of the user is determined based on the profile. This curriculum placement accelerates the user over a lesson having material over which the user is proficient according to the profile. At 510, the user is presented with a lesson from the determined curriculum placement.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamically aligning curriculum to demonstration environment performance of a user, comprising:
obtaining an action of the user in the demonstration environment, wherein the action comprises an interaction with an element of curriculum material;
determining a proficiency of the user with the curriculum material by applying a machine learning model to the action;
assigning, based on the determination, at least one value to a profile of the user indicating a proficiency of the user with the curriculum material;
determining a curriculum placement of the user based on the profile, the curriculum placement accelerating the user over a lesson having material over which the user is proficient according to the profile; and
presenting the user with a lesson from the determined curriculum placement.

2. The method of claim 1, the method further comprising:
assessing, after the user has been presented with the lesson, whether the user successfully learned material in the lesson; and
creating an association in the machine learning model between the action, the curriculum placement, and the assessment of whether the user successfully learned the material in the lesson.

3. The method of claim 2, wherein the assessing whether the user successfully learned material in the lesson further comprises obtaining a subsequent action of the user in the demonstration environment.

4. The method of claim 1, wherein particular elements in the demonstration environment are associated with particular placements in the curriculum.

5. The method of claim 1, wherein the element of the curriculum material is an interactive digital item configured to simulate upon interaction a process taught in the curriculum material.

6. The method of claim 5, wherein the action comprises a speed, confidence, and success of the interaction with the element and wherein the determining the proficiency further comprises weighting the speed, confidence, and success of the interaction in the machine learning model.

7. The method of claim 1, wherein the demonstration environment provides a virtual sandbox customized to the curriculum material.

8. An electronic computation device comprising:
a processor;
a memory coupled to the processor, the memory containing instructions, that when executed by the processor, cause the electronic computation device to:
obtain an action of the user in the demonstration environment, wherein the action comprises an interaction with an element of curriculum material;
determine a proficiency of the user with the curriculum material by applying a machine learning model to the action;
assign, based on the determination, at least one value to a profile of the user indicating a proficiency of the user with the curriculum material;
determine a curriculum placement of the user based on the profile, the curriculum placement accelerating the user over a lesson having material over which the user is proficient according to the profile; and
present the user with a lesson from the determined curriculum placement.

9. The electronic computation device of claim 8, wherein the memory further comprises instructions, that when executed by the processor, cause the electronic computation device to:
assess, after the user has been presented with the lesson, whether the user successfully learned material in the lesson; and
create an association in the machine learning model between the action, the curriculum placement, and the assessment of whether the user successfully learned the material in the lesson.

10. The electronic computation device of claim 9, wherein the assessing whether the user successfully learned material in the lesson further comprises obtaining a subsequent action of the user in the demonstration environment.

11. The electronic computation device of claim 8, wherein particular elements in the demonstration environment are associated with particular placements in the curriculum.

12. The electronic computation device of claim 8, wherein the element of the curriculum material is an interactive digital item configured to simulate upon interaction a process taught in the curriculum material.

13. The electronic computation device of claim 12, wherein the action comprises a speed, confidence, and success of the interaction with the element and wherein the determining the proficiency further comprises weighting the speed, confidence, and success of the interaction in the machine learning model.

14. The electronic computation device of claim 8, wherein the demonstration environment provides a virtual sandbox customized to the curriculum material.

15. A computer program product for an electronic computation device comprising a computer readable storage medium having program instructions embodied therewith, the program instructions executable by a processor to cause the electronic computation device to:
obtain an action of the user in the demonstration environment, wherein the action comprises an interaction with an element of curriculum material;
determine a proficiency of the user with the curriculum material by applying a machine learning model to the action;
assign, based on the determination, at least one value to a profile of the user indicating a proficiency of the user with the curriculum material;
determine a curriculum placement of the user based on the profile, the curriculum placement accelerating the user over a lesson having material over which the user is proficient according to the profile; and
present the user with a lesson from the determined curriculum placement.

16. The computer program product of claim 15, wherein the computer readable storage medium further comprises program instructions, that when executed by the processor, cause the electronic computation device to:
assess, after the user has been presented with the lesson, whether the user successfully learned material in the lesson by obtaining a subsequent action of the user in the demonstration environment; and
create an association in the machine learning model between the action, the curriculum placement, and the assessment of whether the user successfully learned the material in the lesson.

17. The computer program product of claim 15, wherein particular elements in the demonstration environment are associated with particular placements in the curriculum.

18. The computer program product of claim 15, wherein the element of the curriculum material is an interactive digital item configured to simulate upon interaction a process taught in the curriculum material.

19. The computer program product of claim 18, wherein the action comprises a speed, confidence, and success of the interaction with the element and wherein the determining the proficiency further comprises weighting the speed, confidence, and success of the interaction in the machine learning model.

20. The computer program product of claim 15, wherein the demonstration environment provides a virtual sandbox customized to the curriculum material.
